(19) United States
(12) Patent Application Publication
(10) Pub. No.: US 2007/0223390 A1
(43) Pub. Date: Sep. 27, 2007

(54) COMMUNICATION APPARATUS AND COMMUNICATION METHOD

(75) Inventors: Tsuyoshi KOBAYASHI, Tokyo (JP); Kazunori KOTAKA, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI ELECTRIC CORPORATION, Chiyoda-ku (US)

(21) Appl. No.: 11/424,766

(22) Filed: Jun. 16, 2006

(30) Foreign Application Priority Data
Mar. 27, 2006 (JP) 2006-085611

(51) Int. Cl. H04J 1/16

(52) U.S. Cl. 370/252; 370/392

(57) ABSTRACT

A communication apparatus transmits data by adaptively selecting at least one of an error-correction coding rate and a modulation method so that the error rate of data transmission is within a target error rate at a destination. In the communication apparatus, a transmission-parameter generating unit selects at least one of an error-correction coding rate and a modulation method based on the number of hops, transmission channel characteristics, and the target error rate, thus generating at least one transmission parameter, and an error-correction coding unit and a modulating unit adaptively perform either or both error-correction coding and modulation according to the transmission parameter.

### BACKGROUND OF THE INVENTION

1. Field of the Invention

The present invention relates to a technology for transmitting data from a source communication apparatus to a destination communication apparatus in a communication network system.

2. Description of the Related Art

In wireless communication, it is common to adaptively select an error correction coding rate and modulation scheme according to the state of transmission channels to improve the quality of communication. For example, Japanese Patent Application Laid-Open No. 2003-219470 discloses a communication apparatus that adaptively changes one or more transmission parameters, which are modulation method, coding rate, and information transmission rate (transfer rate), based on transmission channel state, and transmits data by using the changed transmission parameter. FIG. 8 is an example of a selection chart used to select a transmission parameter in Japanese Patent Application Laid-Open No. 2003-219470.

Besides, in a communication network including a plurality of communication apparatuses, a data-transfer method, such as relay transmission or multi-hop transmission, is used to transfer data from a sender to a receiver via at least one communication apparatus. For example, Japanese Patent Application Laid-Open No. 2004-32393 discloses a technology that enables higher-speed relay transmission. According to the technology, in a relay network (communication network) including a plurality of relay stations, a master station detects relay path candidates from a sender to a receiver of data, compares the detected relay path candidates, and selects an optimal path from among the detected relay path candidates. The optimal path is a path with the smallest sum of the inverse carrier-to-noise ratios (CNR) of respective links therein, a path with the smallest sum of the bit error rates (BER) of respective links therein, a path with the smallest sum of packet loss rates, or a path with the least number of hops. Thus, adaptive multistage relaying is performed.

However, in Japanese Patent Application Laid-Open No. 2003-219470, a transmission parameter is determined such that data to be transmitted always has a fixed error rate. Consequently, if this technology is applied to a data-relay communication network including the conventional communication apparatuses, an increase in the number of hops from a sender to a receiver increases an end-to-end (sender to receiver) error rate. Assuming that, for example, a transmission parameter is determined such that an error rate of each link is 1.0 percent, the end-to-end error rate increases to 9.56 percent (=1−(1−0.01)×10) when 10 stages of relaying is performed. If the end-to-end error rate exceeds the error rate required for data transfer, the data transfer is wasted.

In the conventional technology described in Japanese Patent Application Laid-Open No. 2004-32393, a path with the least error rate is selected as an optimal path from relay path candidates. However, the error rates of all the links can be substantially same, or even the lowest error rate can be higher than the necessary error rate, so that it can be sometimes difficult to select a path.

Besides, the technology assumes that the relay stations form a mesh-type communication network, and an optimal path can be selected from a plurality of paths in the communication network. If the technology is applied to a communication network that does not permit a physical or logical loop to be configured and is necessitated to have a tree structure, a relay path from a sender to a receiver is uniquely determined. Therefore, data transfer is performed only at the error rate obtained from the path.

In addition, the number of hops may vary according to a combination of sender and receiver apparatuses. According to an adaptive modulation and coding scheme as described in Japanese Patent Application Laid-Open No. 2003-219470, in which a transmission parameter is determined to achieve a fixed error rate for each link, the end-to-end error rate varies depending on the number of hops. Thus, the available number of relay operations is limited. Generally, when a target error rate is restricted, a lower-bit modulation or a transmission parameter with high redundancy is selected, which reduces communication speed. If the maximum number of hops is defined to predetermine a selection condition for transmission parameter so that the target error rate can be achieved for the maximum number of hops, an excessive error rate is set (selected) for relay transmission by hops less than the maximum number of hops. Thus, the transfer rate is unnecessarily reduced.

### SUMMARY OF THE INVENTION

It is an object of the present invention to at least partially solve the problems in the conventional technology.

According to an aspect of the present invention, a communication apparatus that constitutes a communication network in which data is transferred through a relay path including at least one relay link from a data-transfer origin to a destination so that an error rate of data transfer is within a target error rate at the destination, includes a transmission-parameter generating unit that adaptively selects at least one of an error-correction coding rate and a modulation method for data to be transferred based on number of relay links in a relay path, characteristics of a transmission channel between the communication apparatus and a next-hop communication apparatus, and the target error rate to generate at least one transmission parameter; and an adaptive-modulation coding unit that performs at least one of error-correction coding and modulation of the data depending on contents of the transmission parameter.

According to another aspect of the present invention, a communication method of transferring data through a relay path including at least one relay link from a communication apparatus at a data-transfer origin to a communication apparatus at a destination in a communication network so that an error rate of data transfer is within a target error rate at the destination, includes adaptively selecting at least one of an error-correction coding rate and a modulation method for data to be transferred based on number of relay links in a relay path, characteristics of a transmission channel between the communication apparatus at the data-transfer origin and a next-hop communication apparatus, and the target error rate to generate at least one transmission parameter; and performing at least one of error-correction coding and modulation of the data depending on contents of the transmission parameter.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a detailed functional block diagram of a communication apparatus according to a first embodiment of the present invention;

FIG. 2 is a schematic of a communication network to which can be applied the communication apparatus shown in FIG. 1;

FIG. 3 is a schematic of a relay communication network including the communication apparatus;

FIG. 4 is a graph for explaining the relation between error rate and estimated transmission-channel characteristics for each modulation method;

FIG. 5 is a detailed functional block diagram of a communication apparatus according to a second embodiment of the present invention;

FIG. 6 is a detailed functional block diagram of a communication apparatus according to a third embodiment of the present invention;

FIG. 7 is an example of the structure of data added with control information; and

FIG. 8 is an example of a selection chart used to select a transmission parameter in conventional wireless communication.

### DETAILED DESCRIPTION OF THE PREFERRED EMBODIMENTS

Exemplary embodiments of the present invention are explained below in detail with reference to the accompanying drawings, wherein like reference numerals designate like parts in the figures.

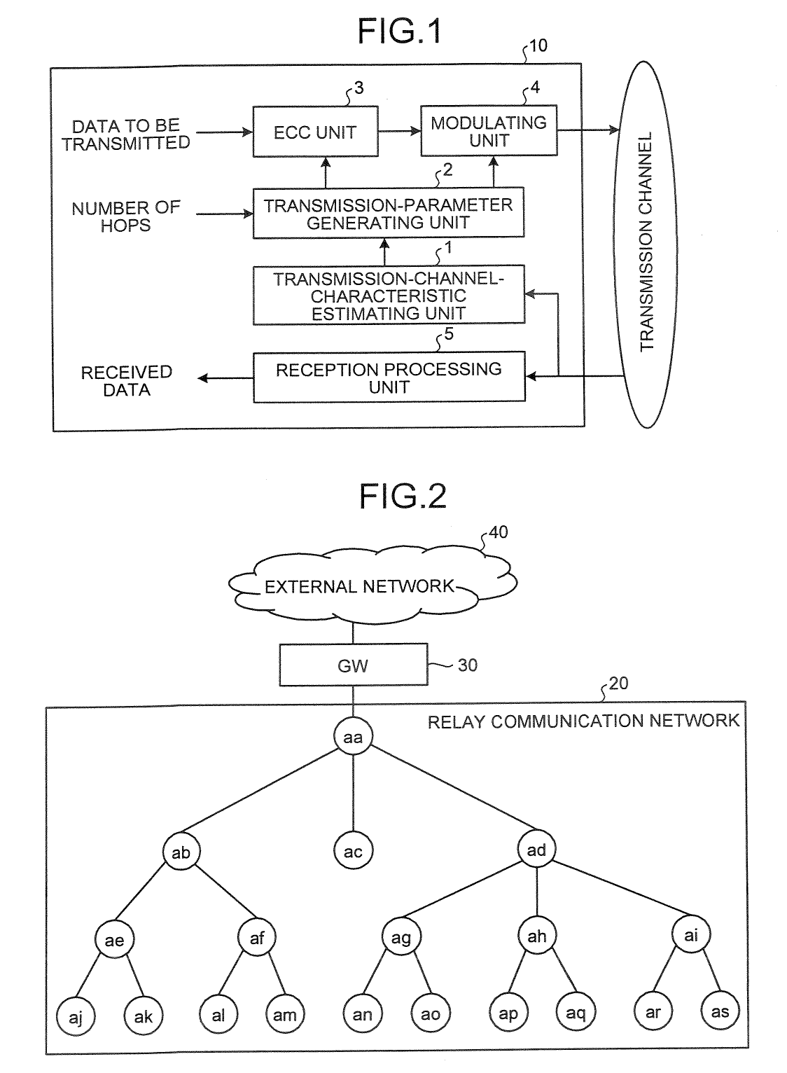

FIG. 1 is a detailed functional block diagram of a communication apparatus 10 according to a first embodiment of the present invention. The communication apparatus 10 includes a transmission-channel-characteristic estimating unit 1, a transmission-parameter generating unit 2, an error-correction coding (ECC) unit 3, a modulating unit 4, and a reception processing unit 5.

The transmission-channel-characteristic estimating unit 1 estimates transmission-channel characteristics. The transmission-parameter generating unit 2 determines transmission parameters, such as an error-correction coding rate (hereinafter, ECC rate) and a modulation method, based on estimated transmission-channel characteristics and the number of hops between a data-transfer origin and a destination (destination communication apparatus).

The ECC unit 3 receives data to be transmitted, and error-correction encodes the data based on the ECC rate determined by the transmission-parameter generating unit 2. The modulating unit 4 modulates a signal output from the ECC unit 3 according to the modulation method determined by the transmission-parameter generating unit 2. The reception processing unit 5 converts a communication signal received via a transmission channel to data. The ECC unit 3 and the modulating unit 4 constitute an adaptive modulation and coding (AMC) unit.

FIG. 2 is a schematic of a communication network to which the communication apparatus 10 can be applied. The communication network includes a relay communication network 20, a gateway (GW) 30, and an external network 40. In the relay communication network 20, there are a plurality of relay points where the communication apparatus 10 is located. The GW 30 connects the relay communication network 20 to the external network 40. The relay points form tree-structured transmission channels. An alphabetical character (aa, ab, ac, . . . , as) denotes each relay point and also indicates the address of the relay point. Hereinafter, a relay point with address n (n=aa, ab, ac, . . . , as) is simply referred to as a relay point n.

Incidentally, communication from the communication apparatus at the relay point aa via the GW 30 to the external network 40 is out of the scope of the embodiment. The control of error rate and transfer rate is performed for relay transmission from one communication apparatus to another at each relay point in the relay communication network 20. Such a configuration of the relay communication network is common in wired networks.

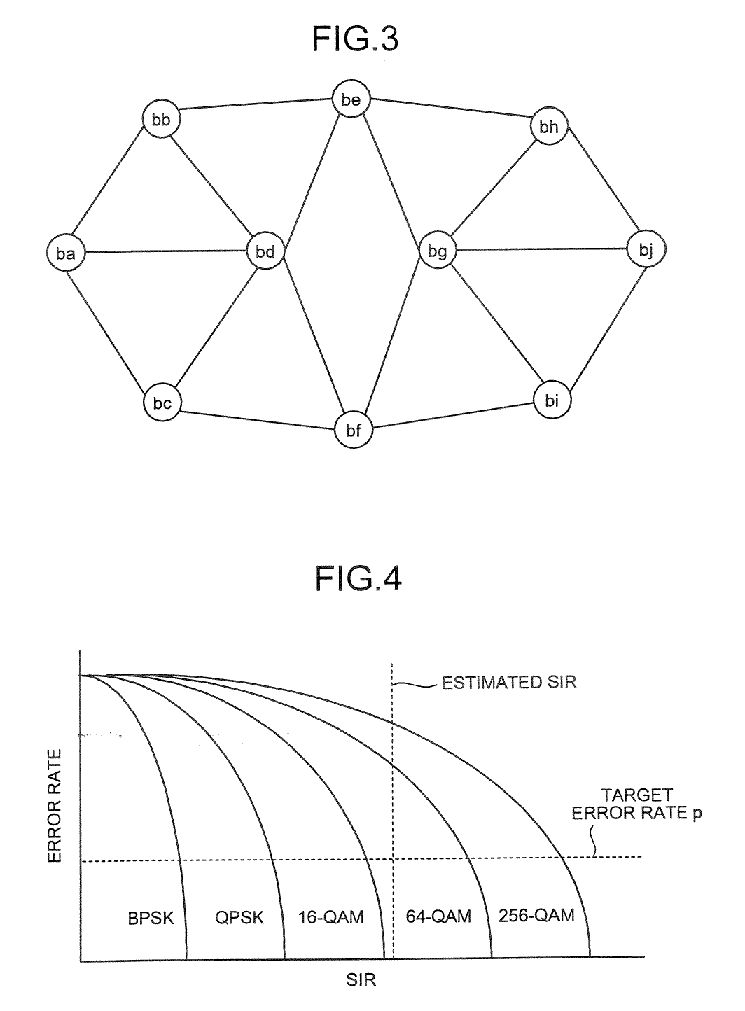

FIG. 3 is a schematic of a relay communication network to which the communication apparatus 10 can be applied. Relay points of FIG. 3 form mesh transmission channels as against the tree-structure in FIG. 2. Such a configuration of the relay communication network is sometimes adopted in wireless networks. Although not shown in FIG. 3, the relay communication network can be connected to an external network via a gateway connected to any one of the relay points (communication apparatuses) in the same manner as that shown in FIG. 2.

The transmission channels in the relay communication networks of FIGS. 2 and 3 are not necessarily physical channels. That is, FIGS. 2 and 3 each show a logical topology. Besides, it is assumed that, in the relay communication network of the first embodiment, each communication apparatus on a relay path has already acquired the relay path or the number of hops between a data-transfer origin to a destination. In a wired or wireless network where the positions of the communication apparatuses are fixed, for example, each communication apparatus obtains network-configuration information from the outside and stores therein the number of hops or a relay path to another apparatus when installed etc. On the other hand, in a mobile communications network or a sensor network where the positions of the communication apparatuses are not fixed, each communication apparatus can use any of various known methods to autonomously acquire the number of hops or a relay path.

In the following, the transmission or transfer of data (user data) performed by the communication apparatus is explained. The explanation below assumes that, in the relay communication network 20, data is transferred from the relay point aa to the relay point aj. P is the target end-to-end error rate. The relay path from the relay point aa to aj is uniquely determined, and can be expressed by the addresses of respective relay points on the path as follows: aa→ab→ae→aj. Thus, the relay path from aa to aj includes three hops. Respective transmission channels as relay links between the relay points aa and ab, ab and ae, and ae and aj have different characteristics. Therefore, the communication apparatus located at each relay point operates in such a manner as presently described to transmit data.

As an example, the operation of the communication apparatus at the relay point aa is explained referring to FIG. 1. The transmission-channel-characteristic estimating unit 1 estimates the transmission-channel characteristics of a relay link. The estimation can be made, for example, by transmitting a reference signal, which every communication apparatus stores therein, over the relay link so that the receiver can compare the reference signal after transmission with the original one to estimate attenuation and phase characteristics, or signal-to-interference ratio (SIR) as transmission-channel characteristics. The estimation of transmission-channel characteristics using a reference signal can be performed at the time of data transfer. Besides, the estimation can be performed on activation of the communication apparatus and repeated at regular intervals to obtain up-to-date estimation results. Also, the estimation can be performed when a packet error is detected a predetermined number of times and deterioration is expected in transmission-channel characteristics. Alternatively, transmission-channel characteristics can be estimated, without the use of a reference signal, from packet transmission history including information such as packet error rate (PER), and error rate characteristics based on the result of error correcting/detecting code modulation.

The transmission-parameter generating unit 2 calculates a target error rate on the relay link based on the number of hops previously obtained. Incidentally, in the first embodiment, the same target end-to-end error rate is allocated (assigned) to all relay paths in the relay communication network 20. A target error rate (target individual error rate) p assigned to each relay link in a relay path is given by

p=1−(1−P)^{1/N}

where P is the target end-to-end error rate in the relay communication network 20, and N is the number of hops (relay links).

Further, the transmission-parameter generating unit 2 generates a transmission parameter that achieves the target individual error rate p based on the transmission-channel characteristics estimated by the transmission-channel-characteristic estimating unit 1. FIG. 4 is a graph for explaining the relation between error rate characteristics and estimation results of transmission-channel characteristics (SIR) for respective modulation methods in the communication apparatus. Consider the case where the communication apparatus is compatible with binary phase shift keying (BPSK), quadrature phase shift keying (QPSK), 16-quadrature amplitude modulation (QAM), 64-QAM and 256-QAM modulations, and the relation between the error rate and SIR is as shown in FIG. 4. In this case, BPSK, QPSK and 16-QAM modulations satisfy the target individual error rate p. The transmission-parameter generating unit 2 determines to use as the transmission parameter 16-QAM, which satisfies the target individual error rate p and is most effective (capable of high-speed transmission) with a large number of modulated bits.

While, in the above description, a modulation method is used as a transmission parameter, an ECC rate can be used instead. In addition, it is possible to use a plurality of transmission parameters, such as a pair of a modulation method and an ECC rate.

When the communication apparatus uses a pair of the modulation method and the ECC rate as transmission parameters, the transmission-parameter generating unit 2 informs the ECC unit 3 and the modulating unit 4 of the determined ECC rate and the modulation method, respectively. Accordingly, the ECC unit 3 and the modulating unit 4 perform AMC. More specifically, the ECC unit 3 error-correction encodes data to be transferred based on the ECC rate informed by the transmission-parameter generating unit 2. The modulating unit 4 moderates the data error-correction encoded by the ECC unit 3 to generate a modulated signal. The modulating unit 4 outputs the modulated signal to a transmission channel (i.e., to the communication apparatus located at the next relay point ab).

When the communication apparatus at the relay point ab receives the modulated signal through the transmission channel, the reception processing unit 5 converts the modulated signal back to the data. Then, the communication apparatus at the relay point ab operates in the same manner as previously described for the communication apparatus at the relay point aa to forward the data to the next relay point ae. By the transfer operation of the communication apparatuses at the relay points on the relay path, the data arrives at the destination: the relay point aj.

The target end-to-end error rate P can be determined in various ways. The target end-to-end error rate P can be determined, for example, using PER or bit error rate (BER). That is, a PER or BER threshold can be set as the target end-to-end error rate P, and used to determine the transmission parameter(s). The target end-to-end error rate P does not necessarily depend on data to be transferred in the relay communication network 20, and can be determined in advance as a fixed value. It is also possible that the target end-to-end error rate P varies according to the type or amount of data.

Besides, the above explanation pertains to the case of data transfer in the relay communication network 20 having a tree structure. However, the first embodiment can also be applied to a mesh-type relay communication network as shown in FIG. 3. If the relay path from a data-transfer origin to a destination is not uniquely determined and there are a plurality of relay paths to the destination, a target error rate is assigned to each relay path according to the number of hops. Thereby, a path with the fastest transfer rate is used to transfer data.

As described above, according to the first embodiment, the communication apparatus at each relay point individually determines a target error rate (target individual error rate) p based on the target end-to-end (data-transfer origin to destination) error rate P and the number of relay links N that constitute the relay path from a data-transfer origin to a destination. Relay transmission is performed based on one or more transmission parameters determined to satisfy the target individual error rate p. Thus, it is possible to achieve the target end-to-end error rate in communication independently of the number of hops.

In addition, the target end-to-end error rate P for data transmission is uniform regardless of the type of data. The same target individual error rate p is assigned to each relay link in a relay path according to the number of hops N. Thus, the communication apparatus at each relay point can individually generate one or more transmission parameters without considering such factors as the difference in target end-to-end error rate due to data type, etc., and transmission-channel characteristics and error rates on the previous and next relay links.

Further, a fixed value is set in advance as the target end-to-end error rate P for all data transferred in the relay communication network. Therefore, data can be transferred by the same process regardless of the type, amount, etc. of data, which simplifies the process.

A communication apparatus according to a second embodiment of the present embodiment is explained below. In the first embodiment the same target individual error rate p is assigned to all relay links in a relay path according to the number of hops N, however, in the second embodiment, a target individual error rate p is assigned to each relay link according to the transmission-channel characteristics of the relay link.

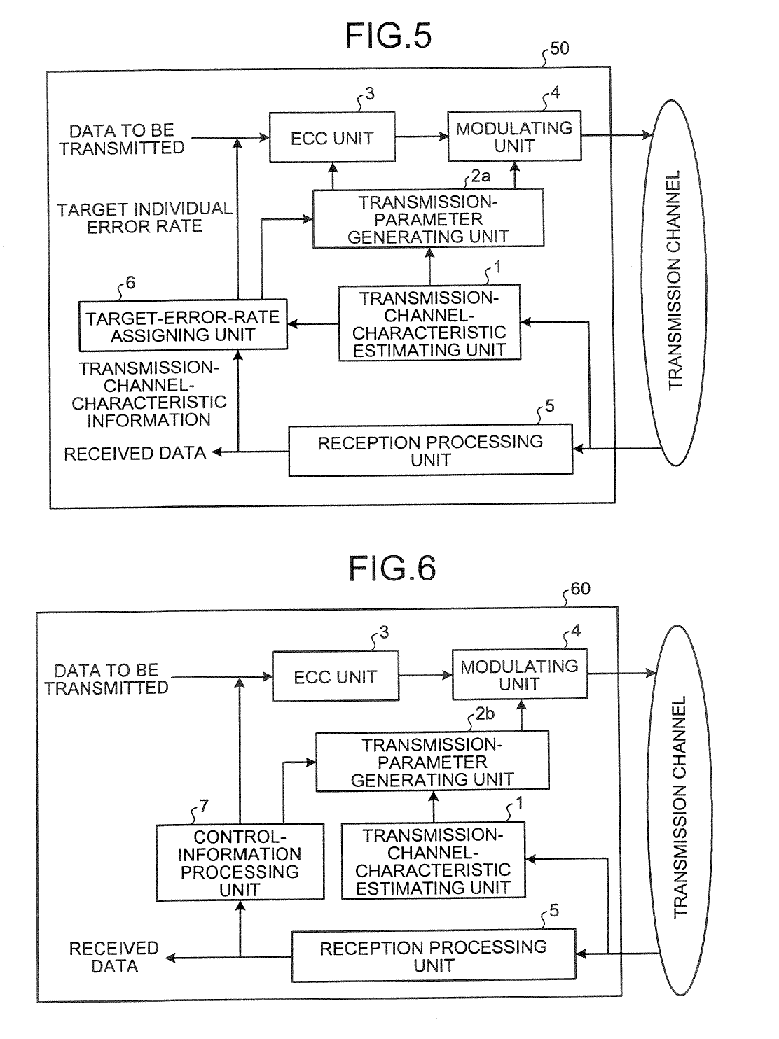

FIG. 5 is a detailed functional block diagram of a communication apparatus 50 according to the second embodiment. The communication apparatus 50 is essentially similar in construction to the communication apparatus 10 except that it includes a target-error-rate assigning unit 6 and a transmission-parameter generating unit 2a in place of the transmission-parameter generating unit 2. Any description for the previous embodiment is incorporated herein insofar as the same is applicable, and the same description is not repeated. The communication apparatus 50 can be arranged at each node in FIG. 2 or 3.

The transmission-parameter generating unit 2a of each communication apparatus determines one or more transmission parameters, such as an ECC rate and a modulation method, based on the transmission-channel characteristics and a target error rate (target individual error rate) on a relay link which the communication apparatus is in charge of (a relay link between the communication apparatus and the next-hop communication apparatus or relay point) obtained from the target-error-rate assigning unit 6.

The target-error-rate assigning unit 6 obtains, from another communication apparatus at each relay point on a data relay path, transmission-channel-characteristic information for a relay link which the other communication apparatus is in charge of. Thereby, the target-error-rate assigning unit 6 assigns a target individual error rate to each relay link. When requested by another communication apparatus for transmission-channel-characteristic information, the target-error-rate assigning unit 6 informs the other communication apparatus of the transmission-channel characteristics of the relay link in its own apparatus's charge. In addition, having received (obtained) from another communication apparatus a target individual error rate assigned to the relay link in its own apparatus's charge, the target-error-rate assigning unit 6 informs the transmission-parameter generating unit 2a of the target individual error rate.

Incidentally, the relay communication network constituted of the communication apparatuses 50 of the second embodiment has the same construction as that of the first embodiment. Further, it is assumed that each communication apparatus on a relay path has already acquired the relay path or the number of hops between a data-transfer origin to a destination.

In the following, the transmission or transfer of data performed by the communication apparatus 50 is explained. The explanation below assumes that, similarly to the first embodiment, in the relay communication network 20 of FIG. 2, data is transferred from the relay point aa to the relay point aj. P is the target end-to-end error rate.

As an example, the operation of the communication apparatus 50 at the relay point aa is explained referring to FIG. 5. At the inception of data transfer, the target-error-rate assigning unit 6 requests the communication apparatuses at the relay points ab and ae to report transmission-channel-characteristic information for relay links in their charge. In addition to transmission-channel-characteristic information received in response to the request, the target-error-rate assigning unit 6 obtains transmission-channel-characteristic information for a relay link between the relay points aa and ab from the transmission-channel-characteristic estimating unit 1.

Based on the transmission-channel-characteristic information for the respective relay links, the target-error-rate assigning unit 6 assigns a target individual error rate p to the relay links to achieve the target end-to-end error rate P. The target individual error rate p is strictly restricted for a relay link with good transmission-channel characteristics, and relaxed for a relay link with poor transmission-channel characteristics. Additionally, the assignment of the target individual error rate p is performed so that transmission parameters determined for the respective relay links derive about the same communication speed.

The communication apparatus at the relay point aa informs the communication apparatuses at the relay points ab and ae of the target individual error rate p assigned by the target-error-rate assigning unit 6 to each of the relay links in their charge. The assignment and report of the target individual error rate p are performed only by the communication apparatus that initiates the data transfer.

Each of the communication apparatuses at the relay points ab and ae determines at least one transmission parameter, such as an ECC rate or a modulation method, which satisfies the target individual error rate p. Based on determined one or more transmission parameters, the communication apparatuses transfer data. Similarly to the first embodiment, any one or a combination of an ECC rate, a modulation method and the like can be used as the transmission parameter(s).

The above explanation pertains to the case of data transfer in the relay communication network having a tree structure. However, the second embodiment can also be applied to a mesh-type relay communication network as with the first embodiment.

Besides, the above explains that, in the communication apparatus at the relay point aa that initiates the data transfer, the target-error-rate assigning unit 6 collects transmission-channel-characteristic information for respective relay links that constitutes a relay path, and assigns a target individual error rate p to the relay links. However, the assignment of the target individual error rate p can always be performed by a specific communication apparatus in the relay communication network.

Further, in the above explanation, the target-error-rate assigning unit 6 of the communication apparatus at the relay point aa assigns a target individual error rate p to each relay link in a relay path, and the communication apparatus informs another communication apparatus on the relay path of the target individual error rate p. Alternatively, the other communication apparatus can be informed of one or more transmission parameters determined for a relay link which the communication apparatus is in charge of.

As described above, according to the second embodiment, based on the number of relay links that constitutes a relay path to a receiver and transmission-channel characteristics of the relay links, the communication apparatus that initiates the data transfer assigns a target individual error rate p to each of the relay links to achieve the target end-to-end error rate P. Additionally, the assignment of the target individual error rate p is performed so that communication speed is about the same on the respective relay links. Thereby, the transfer rate can be increased between a data-transfer origin to a destination. That is, when the same target individual error rate is assigned to each relay link on a relay path based on the number of hops as in the first embodiment, the end to end transfer rate is limited to the transfer rate of a relay link with the worst transmission-channel characteristics. However, in the second embodiment, the target individual error rate is relaxed for a relay link with poor transmission-channel characteristics, which improves the transfer rate that acts as a bottleneck.

Moreover, the communication apparatus that initiates data transfer assigns a target individual error rate to each relay link, and one or more transmission parameters are determined for the relay link before the data transfer. Thus, after the initiation of the data transfer, relay transmission can be performed by a simple process with the same transmission parameter(s).

A communication apparatus according to a third embodiment of the present invention is explained below. In the first and second embodiments, respective communication apparatuses have already acquired the target end-to-end error rate P in the relay communication network and the number of hops in the relay path between a data-transfer origin to a destination. In the third embodiment, however, only the communication apparatus that initiates data transfer is aware of the target end-to-end error rate P and the number of hops prior to data transmission (relay transmission).

FIG. 6 is a detailed functional block diagram of a communication apparatus 60 according to the third embodiment. The communication apparatus 60 is essentially similar in construction to the communication apparatus 10 except that it includes a control-information processing unit 7 and a transmission-parameter generating unit 2b in place of the transmission-parameter generating unit 2. Any description for the previous embodiment is incorporated herein insofar as the same is applicable, and the same description is not repeated. The communication apparatus 60 can be arranged at each node in FIG. 2 or 3.

The transmission-parameter generating unit 2b of each communication apparatus calculates a target individual error rate p on a relay link which the communication apparatus is in charge of based on the transmission-channel characteristics, the number of hops N, and the target end-to-end error rate P obtained by the control-information processing unit 7. Based on the target individual error rate p, the transmission-channel characteristics and the number of hops N, the transmission-parameter generating unit 2b determines one or more transmission parameters, such as an ECC rate and a modulation method.

The control-information processing unit 7 adds control information, such as the type or amount of data and the number of hops in a relay path, to data to be transferred. On receipt of data, the control-information processing unit 7 extracts control information (the type or amount of data, the number of hops in a relay path, etc.) from the output data of the reception processing unit 5. The control-information processing unit 7 informs the transmission-parameter generating unit 2b of the control information.

Incidentally, the relay communication network constituted of the communication apparatuses of the third embodiment has the same construction as that of the first embodiment. Further, it is assumed that the communication apparatus that initiates data transfer has already acquired the number of hops to the receiver of data.

In the following, the transmission or transfer of data performed by the communication apparatus 60 is explained. The explanation below assumes that, similarly to the first embodiment, in the relay communication network 20 of FIG. 2, data is transferred from the relay point aa to the relay point aj. P is the target end-to-end error rate.

As an example, the operation of the communication apparatus 60, which initiates data transfer, at the relay point aa is explained referring to FIG. 6. After the initiation of data transfer, the control-information processing unit 7 checks the number of hops N (N=3 in this example) in the relay path to the receiver of data (user data). Besides, based on the type and amount of the data, etc. to be transferred, the control-information processing unit 7 determines the target end-to-end error rate P, and generates control information to be transmitted with the data using the number of hops N and the target end-to-end error rate P. The target end-to-end error rate P can vary according to the type of the data, e.g., voice over Internet protocol (VoIP) data, moving-image data and general file data, according to the amount of data, or the like. Only the control-information processing unit 7 of the communication apparatus that initiates data transfer performs the process of generating control data including the determination of the target end-to-end error rate P.

The transmission-parameter generating unit 2b is fed with the control information (the number of hops N and the target end-to-end error rate P) generated as above with the transmission-channel characteristics estimated by the transmission-channel-characteristic estimating unit 1. The transmission-parameter generating unit 2b calculates a target individual error rate p on a relay link which the communication apparatus is in charge of based on the number of hops N and the target end-to-end error rate P. The target individual error rate p is given, for example, by p=1−(1−P)^{1/N}. The transmission-parameter generating unit 2b determines one or more transmission parameters, such as an ECC rate and a modulation method, based on the transmission-channel characteristics in the same manner as previously described for the first embodiment. Also similarly to the first embodiment, any one or a combination of an ECC rate, a modulation method and the like can be used as the transmission parameter(s).

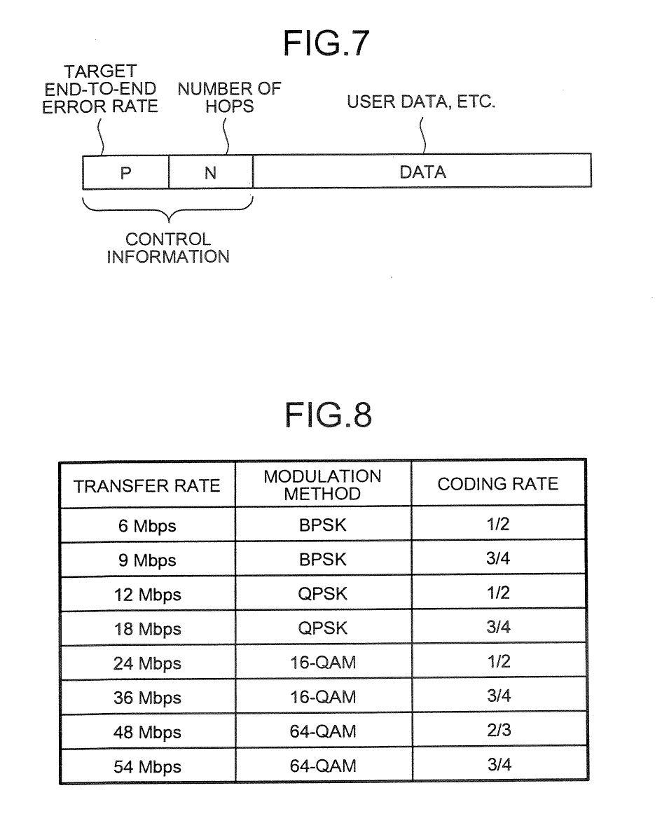

As has been mentioned above, the control information generated by the control-information processing unit 7 is transmitted with the data (user data). FIG. 7 is an example of the structure of the data added with the control information. While, in general, transmitted data contains address information of a sender and a receiver and the like, such information is not part of the present invention and is not described herein.

The data as shown in FIG. 7 is error-correction encoded and moderated by the ECC unit 3 and the modulating unit 4, respectively. After that, the data is transferred via a transmission channel to the communication apparatus at the relay point ab.

In the communication apparatus at the relay point ab that has received the data from the relay point aa, the reception processing unit 5 demodulates the data to obtain a demodulated signal. The reception processing unit 5 then extracts the control information form the demodulated signal to output the control information to the control-information processing unit 7. The control-information processing unit 7 extracts information on the number of hops N and the target end-to-end error rate P from the control information to inform the transmission-parameter generating unit 2b of the information. The extracted control information is also input to the ECC unit 3 to be added again to the data (relayed user data) transferred to the next relay point. The transmission-parameter generating unit 2b calculates a target individual error rate p on a relay link which the communication apparatus is in charge of based on the number of hops N and the target end-to-end error rate P. The transmission-parameter generating unit 2b determines one or more transmission parameters, such as an ECC rate and a modulation method, based on the transmission-channel characteristics, and informs the ECC unit 3 and the modulating unit 4 of the transmission parameters. The data added with the control information undergoes error-correction coding and modulation based on the transmission parameters to be output to a transmission channel (transferred to the next relay point). By the transfer operation of the communication apparatuses at the relay points on the relay path, the data arrives at the destination: the relay point aj.

Incidentally, in the above explanation, control information including the number of hops N and the target end-to-end error rate P is added to data to be transferred. If, however, the target end-to-end error rate P is fixed in the relay communication network regardless of such factors as the type and amount of data to be transferred and stored in all the communication apparatuses, only the number of hops N is required as control information. In this case, each communication apparatus determines one or more transmission parameters based on the target end-to-end error rate P previously obtained, the number of hops N received as control information and the transmission-channel characteristics of a corresponding relay link. Thus, the communication apparatus need not previously acquire such information as network configuration and the number of hops determined by a combination of a data-transfer origin and a destination.

Further, in the above explanation, the target end-to-end error rate P is directly added as control information to data to be transferred. However, when a data frame format is predefined so that data priority information used for general communication, existing control information and the target end-to-end error rate P can be mapped, the target end-to-end error rate P need not be directly added to the data.

While the communication apparatus 60 is obtained by adding the control-information processing unit 7 to the communication apparatus 10, a communication apparatus can be obtained by adding the control-information processing unit 7 to the communication apparatus 50. With this construction, the target individual error rate can be determined according to the transmission-channel characteristics of each relay link.

The above explanation pertains to the case of data transfer in the relay communication network having a tree structure. However, the third embodiment can also be applied to a mesh-type relay communication network as with the first embodiment.

As described above, according to the third embodiment, the communication apparatus that initiates data transfer determines the target end-to-end error rate. With the number of hops previously obtained, the target end-to-end error rate is added as control information to data to be transferred. Thereby, other communication apparatuses on a relay path can obtain information on the target end-to-end error rate and the number of hops from the received data. Thus, the other communication apparatuses need not store such information in advance, which simplifies the construction of the communication apparatus and reduces the process performed by the communication apparatus.

Moreover, the target end-to-end error rate P varies according to the type or amount of data to be transferred. Therefore, the communication apparatuses can perform transfer operation more flexibly according to the type or amount of data.

As set forth hereinabove, according to the embodiments, the communication apparatus individually determines a target error rate (target individual error rate) based on the target end-to-end error rate and the number of relay links that constitutes a relay path from a data-transfer origin to a destination. Relay transmission is performed based on one or more transmission parameters determined to satisfy the target individual error rate. Thus, it is possible to achieve the target end-to-end error rate in communication independently of the number of hops.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A communication apparatus that constitutes a communication network in which data is transferred through a relay path including at least one relay link from a data-transfer origin to a destination so that an error rate of data transfer is within a target error rate at the destination, the communication apparatus comprising:
a transmission-parameter generating unit that adaptively selects at least one of an error-correction coding rate and a modulation method for data to be transferred based on number of relay links in a relay path, characteristics of a transmission channel between the communication apparatus and a next-hop communication apparatus, and the target error rate to generate at least one transmission parameter; and
an adaptive-modulation coding unit that performs at least one of error-correction coding and modulation of the data depending on contents of the transmission parameter.

2. The communication apparatus according to claim 1, wherein
the target error rate is the same on all relay paths in the communication network, and
the transmission-parameter generating unit calculates an individual error rate on a corresponding relay link in a relay path used to transfer data to satisfy the target error rate, and selects at least one of the error-correction coding rate and the modulation method based on the number of relay links, the characteristics of the transmission channel, and the individual error rate.

3. The communication apparatus according to claim 1, further comprising:
a data-transfer initiating unit that initiates the data transfer; and
an individual-error-rate calculating unit that obtains the characteristics of each relay link in a relay path used to transfer data, and calculates an individual error rate on the relay link based on obtained characteristics and the target error rate, wherein
the transmission-parameter generating unit selects at least one of the error-correction coding rate and the modulation method based on the number of relay links, the characteristics of the transmission channel, and the individual error rate.

4. The communication apparatus according to claim 3, further comprising:
a data relaying unit that relays data from a previous-hop communication apparatus to a next-hop communication apparatus; and
an individual-error-rate obtaining unit that obtains the individual error rate from a communication apparatus that initiates the data transfer, wherein
the transmission-parameter generating unit selects at least one of the error-correction coding rate and the modulation method based on the number of relay links, the characteristics of the transmission channel, and the individual error rate.

5. The communication apparatus according to claim 1, wherein the target error rate is non-variable.

6. The communication apparatus according to claim 1, wherein the target error rate varies according to at least one of type and amount of data to be transferred.

7. The communication apparatus according to claim 1, further comprising:
a data-transfer initiating unit that initiates the data transfer;
a target-error-rate determining unit that determines a target error rate at a destination according to at least one of type and amount of data to be transferred; and
a control-information generating unit that generates control information including a determined target error rate and number of relay links in a relay path to the destination, wherein
the transmission-parameter generating unit selects at least one of the error-correction coding rate and the modulation method based on the control information and the characteristics of the transmission channel, and
the adaptive-modulation coding unit performs at least one of the error-correction coding and the modulation of the data added with the control information.

8. The communication apparatus according to claim 7, further comprising:
a data relaying unit that relays data from a previous-hop communication apparatus to a next-hop communication apparatus; and
a control-information extracting unit that extracts the control information from the data, wherein
the transmission-parameter generating unit selects at least one of the error-correction coding rate and the modulation method base on extracted control information and the characteristics of the transmission channel.

9. A communication method of transferring data through a relay path including at least one relay link from a communication apparatus at a data-transfer origin to a communication apparatus at a destination in a communication network so that an error rate of data transfer is within a target error rate at the destination, the communication method comprising:
adaptively selecting at least one of an error-correction coding rate and a modulation method for data to be transferred based on number of relay links in a relay path, characteristics of a transmission channel between the communication apparatus at the data-transfer origin and a next-hop communication apparatus, and the target error rate to generate at least one transmission parameter; and
performing at least one of error-correction coding and modulation of the data depending on contents of the transmission parameter.
